(19) United States
(12) Patent Application Publication
(10) Pub. No.: US 2003/0048195 A1
(43) Pub. Date: Mar. 13, 2003

(54) Apparatus and method to sense and subscribe to presence information

(76) Inventor: Dirk Trossen, Arlington, MA (US)

Correspondence Address: ROBERT C. ROLNIK, NOKIA INC., 6000 CONNECTION DRIVE, MD 1-4-755, IRVING, TX, 75039, US

(21) Appl. No.: 09/943,991

(22) Filed: Aug. 31, 2001

(51) Int. Cl. H04Q 5/22; G08B 5/22

(52) U.S. Cl. 340/825.49; 340/10.1

(57) ABSTRACT

A system and method to provide a presence user agent (207) capable of receiving tag identifiers from a tagging sensor (205) and possibly tag statuses. The presence user agent (207) may send the tag identifier, tagging sensor identifier, and other associated data to a Session Initiation Protocol Presence Server (201). SIP Presence Server (201) may send a message based on the tag identifier and tagging sensor identifier to a requesting entity (211).

### BACKGROUND

This invention relates to distributing and collecting data concerning presence. In particular the invention relates to distribution and collecting data concerning ad hoc arrivals, departures, and statuses.

The ability to track persons and goods is of growing importance. Rudimentary devices, such as electronic eyes, routinely used in burglar systems, provide a simple on-off kind of presence detection. More sophisticated presence detection is available with sensors that can read unique electronic identifiers at a distance, including the Radio Frequency Identifier (RFID) tags frequently used to provide for, e.g., payment accompanying a person or vehicle's presence.

With the growing interconnectedness of sensors, cameras, and other devices having embedded CPUs there is a need to assemble the collective data from the mosaic of these and other tagging devices to track movements of one or more tags or electronically responsive devices carrying unique identifiers.

The Session Initiation Protocol (SIP) is an application-layer protocol. The primary purpose of SIP is a rendezvous function, to allow a request initiator to deliver a message to a recipient wherever he or it is. Such rendezvous is needed to establish a session, but can be used for other purposes related to communications, such as querying for capabilities or delivery of an instant message.

A modified version of a Session Initiation Protocol (SIP) has been shown to be applicable for conveying data concerning a detection of a unique identifier according to a message sent in a SUBSCRIBE message. In the context of such an extended SIP scheme, a Presence User Agent (PUA), which may be a tagging device, issues REGISTER messages when a unique identifier is detected. A Presence Agent (PA) may receive such messages from one or more Presence User Agents. Therein is provided a message format for SUBSCRIBE messages which permit a client or watcher device to name or identify a unique identifier based on a pair of fields, including a user field and a domain field. The SIP scheme provides for a SIP Uniform Resource Identifier (URI) in the format of user@domain. This is helpful, but provides no framework for tying the name or identity to a geographic location. Moreover, use of such a formatted SUBSCRIBE message can be inefficient when transmitting multiple SUBSCRIBE messages in individual packets, which may occur when a client wants to track a set of persons or goods carrying multiple tags or where subscriptions are intended to cover multiple tagging devices or geographic locations. What is needed is a SUBSCRIBE message that can handle, in a few, and preferably one packet, the need to track or otherwise locate at least one tag through one or more locations.

U.S. Pat. No. 6,084,512, “Method And Apparatus For Electronic Labeling And Localizing” discloses a combination of central interrogator and remote tags whereby the interrogator sends a signal containing a unique identifier matching a tag. The tag, upon recognizing a match between an internally stored identifier and the received signal, responses with a response signal. The interrogator is able to identify the tag by the fact that the tag replied to the most recently sent signal from the interrogator.

U.S. Pat. No 5,708,423, “Zone-Based Asset Tracking And Control System” shows another locating system. There a system of machines includes a reader, a control module and a host. The reader reads signals from a marker. The marker signal preferably uniquely identifies the marker. The marker reader may be associated with a portal or doorway. The host receives signals from associated equipment that include a marker ID, identification of an employee badge, data identifying the portal through which movement occurred, direction of movement through the portal and time of movement. The reader posts this information to the local controller. The local controller dispatches this information to the host. The portal is the interface between zones. The host logs movement from a zone of a marker ID. The host logs movement into a zone of a marker ID.

One prior art system for transmitting the current status of a user is that described in FIG. 1, a sequence of messages between a Presence User Agent (PUA) as conceived in Internet Draft “SIP Extensions for Presence” (March 2001, Rosenberg et al), hereinafter referred to as Rosenberg. There a Presence User Agent 101 reports a status in relation to a keyboard to a Server 103. The PUA 101 sends a REGISTER message 105 and receives back an acknowledgement 107.

Rosenberg defines user presence as the willingness and ability of a user to communicate with other users on the network. Historically, presence has been limited to “on-line” and “off-line” indicators. Presence may also include a subscription to and notification of changes in the communication state of a user. This communication state consists of the set of communications means, communications address, and status of that user. A presence protocol may be a protocol for providing such a service over the Internet or any IP network.

However, these techniques have the limitation(s) that objects tracked are shown within systems under a common host or central administration. This is fine for controlling inventory in a warehouse, where once goods are sold, it no longer is of concern the location and state of the goods tracked. This has obvious limitations when the desired objective is to track people or other items that move from the sensory range of one network under administration to another network under a separate administration.

In addition, the foregoing developments fail to show a method of communicating a subscription of a tag identifier and location

The above-mentioned references are exemplary only and are not meant to be limiting in respect to the resources and/or technologies available to those skilled in the art.

### SUMMARY

An embodiment of the invention provides a way for receiving a registration having a portion of data, e.g., a presence portion. Subsequently, a subscribe message may be received having at least one criterion. The at least one criterion may match the portion. Consequently, a notify message may be transmitted wherein the notify message has at least the notify portion.

Another embodiment may be a tagging sensor for receiving a tag identifier. The embodiment may transmit the tag identifier as well as an identifier of the tagging sensor embodiment to a subscription network center or SIP Presence Server (SPS). Such a combination of tag identifier and tagging sensor identifier may be a unit of data called a presence.

One or more of the embodiments may advantageously report to a subscriber or watcher some presence information concerning the location of a tag, or the identity of tags in the sensory range of a tagging sensor, among other things. One or more of the embodiments may make use of a widely implemented application-layer protocol to support packets or messages that carry details concerning the reporting or requesting of presence information.

These and other features, aspects, and advantages of embodiments of the present invention will become apparent with reference to the following description in conjunction with the accompanying drawings. It is to be understood, however, that the drawings are designed solely for the purposes of illustration and not as a definition of the limits of the invention, for which reference should be made to the appended claims.

### BRIEF DESCRIPTION OF THE DRAWINGS

The disclosed embodiments of the invention will be described with reference to the accompanying drawings, wherein:

FIG. 1 is a prior art sequence of messages;

FIG. 2A is a block diagram of a system of tagging sensors according to the embodiment;

FIG. 2B is a sequence of messages according to an embodiment;

FIG. 3 is sequence of messages according to an embodiment;

FIG. 4 is a sequence of messages including a SUBSCRIBE message sent by operation of an embodiment; and

FIG. 5 is a presence server according to an embodiment.

### DETAILED DESCRIPTION

The Session Initiation Protocol is defined in, M. Handley, H. Schulzrinne, E. Schooler, and J. Rosenberg, “SIP: Session Initiation Protocol,” Request for Comments 2543, Internet Engineering Task Force, March 1999, which is incorporated by reference, and hereinafter referred to as “Handley”. The Session Initiation Protocol (SIP) is an application-layer control (signaling) protocol for creating, modifying, and terminating sessions with one or more participants among other things. These sessions may include Internet multimedia conferences, Internet telephone calls, and multimedia distribution. Members in a session can communicate via multicast or via a mesh of unicast relations, or a combination of these. SIP invitations, used to create sessions, carry session descriptions, which allow participants to agree on a set of compatible media types. SIP supports user mobility by proxying and redirecting requests to the user's current location. Users can register their current location. SIP is not tied to any particular conference control protocol. SIP is designed to be independent of the lower-layer transport protocol and can be extended with additional capabilities.

SIP may be extended to permit alternate and additional fields in messages than as specified in the Handley SIP document.

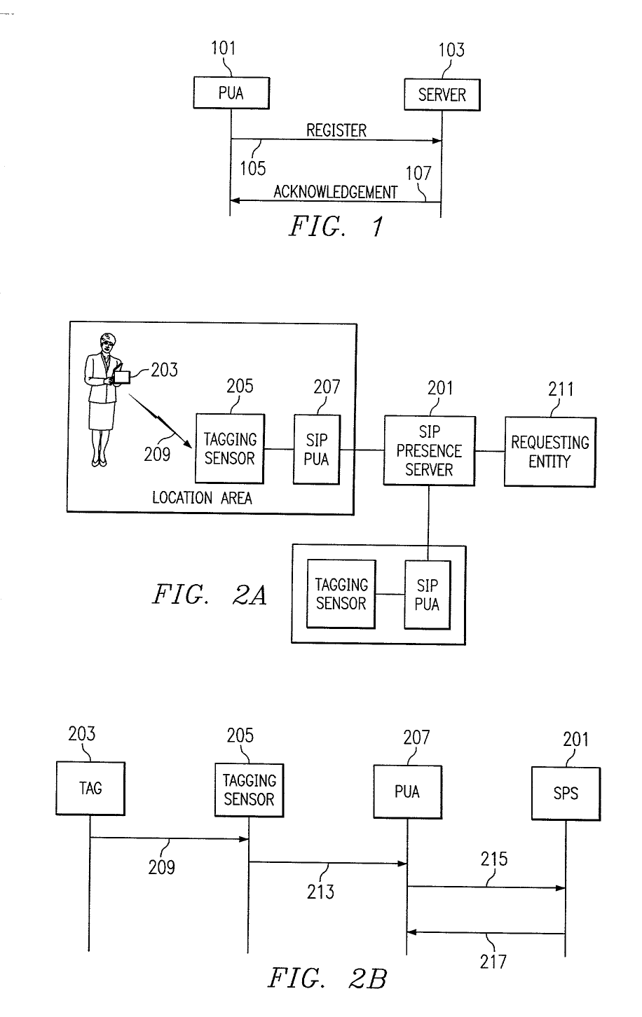

FIG. 2A shows a block diagram of a system of tagging sensors that report to a central presence server, which may be a Session Initiation Protocol (SIP) Presence Server (SPS) 201. Presence information may additionally include data concerning the location of a device, wherein the device may be associated with a user, e.g., a radio-responsive, user-worn tag. A tag or other wirelessly responsive device 203 may move within range of a tagging sensor 205. The tagging sensor 205 may demodulate signals or otherwise wirelessly read the tag 203 to obtain digital information concerning the tag 203. A SIP Presence User Agent (PUA) 207 may combine any string reported by a signal 209 of the tag 203, such as, e.g., a user name, with a unique identifier of the tagging sensor 205. The PUA 207 may, in turn, transmit an augmented or register message to the SIP Presence Server 201, which may be a packet containing a presence uniform resource identifier (URI), known simply as a presence. Such a presence may be compliant to SIP and its extensions, and be formatted as pres:xxxx@yyyyy, wherein the ‘xxxx’ represents the identifier of the tag 203 and the ‘yyyy’ represents the identifier of the tagging sensor 205. As may be appreciated, there are other formats that may be used if a protocol other than SIP is desired.

The Presence Server 201 may be a centralized computing element or it may be a collection of computing elements networked together, perhaps across a global network. The presence server may be addressable as a network node, even though the presence server may in fact be distributed. Thus, the presence server is a network node comprising at least one computing element. The embodiment of the Presence Server 201 may receive and transmit packets according to SIP, in which case the presence server 201 is called a SIP Presence Server, or SPS 201. The SPS 201 may store the presence URI for later retrieval.

A requesting entity 211, which may be a machine in the vicinity of a subscriber, may have a connection to the SIP Presence Server 201. The requesting entity 211 may establish a subscription with the presence server 201 by sending information concerning at least one tag or at least one tagging sensor to the presence server in a subscribe message.

FIG. 2B shows the sequence of signals according to an embodiment that couples a tag with a tagging sensor or otherwise concatenates identifiers of the tag with the tagging sensor. Tag 203 sends a signal 211 or otherwise provides a signal 213 to the tagging sensor 205. Tagging sensor 205 provides a tagging signal 213 to the Presence User Agent 207. The tagging signal 213 may comprise at least an identifier of the tag and an identifier of the tagging sensor. Combined, the tag identifier and the tagging sensor identifier may be a presence. Presence User Agent 207 may send a register message 215 to a SPS 201. SPS 201 may send an acknowledgement 217, as described in the Handley SIP.

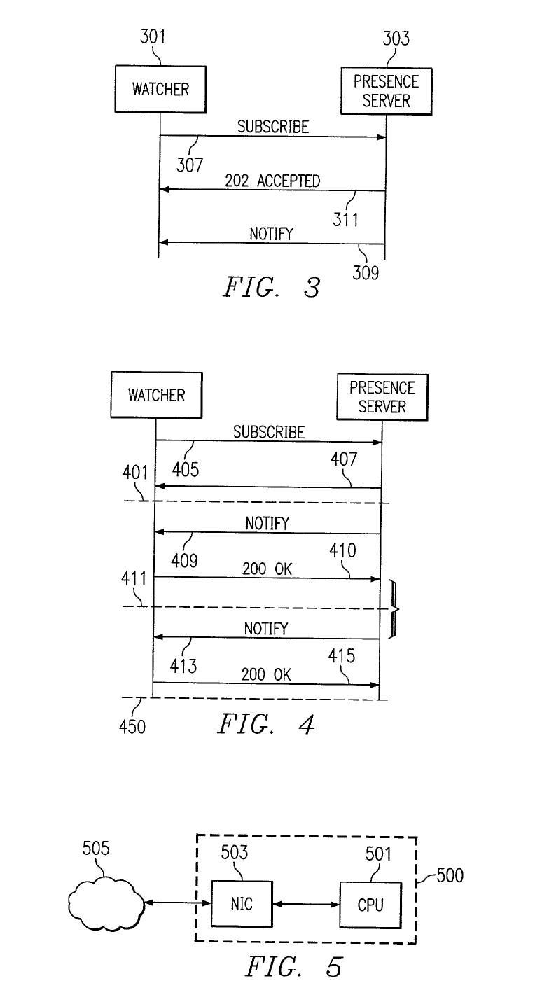

FIG. 3 shows a sequence of messages that may occur during and following a subscribe message between a watcher or requesting entity 301 and a SPS 303. The process is started by the requesting entity 301, sending a subscribe message 307, which will be described in detail shortly. The subscribe message 307 may contain at least one criterion, which is treated as a request at the SPS 303 to match the criterion to available data showing a coupling of tags to tagging sensors, and subsequently report such a match to the requesting entity 301. The criterion may specify zero or more tags. The at least one criterion may specify zero or more tagging sensors.

Following receipt of a subscribe 307 message, the SPS 303 may provide an acknowledgement message back to the requesting entity 301, wherein the acknowledgement message may be an accepted 305 message, according to the SIP protocol specified in Handley.

The SPS 303 may send to the requesting entity 301 information concerning a status of a tag. Status may include designations of availability, e.g., “open” or “closed”, as well as others that indicate some condition at or near the tag, e.g., “moving”. The status information may indicate willingness and ability of a user to communicate with other users. The status information may represent a present state of a user or device. The status information may represent a transition. For example, the “open” status may represent an entrance into a region that may be sensed by the tagging sensor. Similarly, the “closed” status may represent a departure from a region that may be sensed by the tagging sensor. Such information may be passed as a notify 309 message compliant with SIP. The status information may be a short set of bits agreed upon between manufacturers of PUAs and SPS 303 to represent the more conceptual notions of open, closed, and moving.

The subscribe message 307 may include a criterion. The at least one criterion may be:

A) match at least one tag, i.e., a tag criterion; or

B) match at least one location, i.e., a tagging sensor criterion; or

C) match both at least one tag and at least one location, i.e., a criteria comprising a tag criterion and a tagging sensor criterion or

D) match any of the above criteria and a status setting.

Component parts of the subscribe message 307, the accepted message 305, and the notify message 309 may be made up of one or more fields according to the Handley SIP specification.

The tagging sensor may have a unique identifier or string of the tagging sensor within, e.g., a domain. Thus, the tagging sensor may be the unique identifier by itself, or it may be a combination of the tagging sensor string with the domain string. In one embodiment of the invention, the unique identifier comprises human-understandable terms, such as a “room 1”, “1240_Waterford Ct.”, “lobby”, and may itself have different levels of scope or granularity, some with clearly defined borders, and others with borders that may shift with variations in the radio or other wireless environments. In other words, the human-understandable terms may be identical or similar to identifications of locations by signs and understood purposes and functions of a location.

This leads then to a convenient adoption of a naming scheme for a tag location, which may permit powerful use of wildcards to expand a criterion for matching on the basis of conventionally understood ways of identifying location well known since the days signposts and maps were first invented. The following string represents a coupling of a tag to a tagging sensor, such as may occur when a tag is detected by a tagging sensor:

<tag>@<location>.<domain>

wherein the word in angle brackets ‘< >’ represents a string of arbitrary length at least one character long. <tag> may be a name of a person which is stored in the tag; <location> may be a unique identifier of the tagging sensor that detects such a tag; <domain> may be a network domain under common administrative control, or other domain designator as is known in the art. The tag identifier may be the <location> string. The tag identifier may be the <location> string and the <domain> string together. The tag identifier must be unique within the domain under common administrative control. The tag identifier may be unique among all domains. A protocol compliant set of characters may be allowed for each of the strings, such as the characters permissible in the SIP protocol. The character ‘@’ may serve to delimit the tag portion of the coupling from the tagging sensor portion of the coupling. The tag portion may be a tag identifier. The tagging sensor portion may be merely the <location> string or the <location> string and the <domain> string, including a delimiter between the <location> and <domain>. The tagging sensor portion may be a tagging sensor identifier.

Assignment of <tag> identifiers to tags is such that the tag identifier is unique within the scope of the technology of the tagging exchange medium. For example, if a mobile telephone is the technology, and the tag is affixed to a mobile telephone, then a telephone number may be the tag identifier.

Table 1 shows the registered presence of two tags that may be sensed by multiple tagging sensors at three times. The table represents a coupling of a tag identifier with a unique identifier of a sensor.

TABLE 1

| Time 1 | Time 2 | Time 3 |
|---|---|---|
| 7815551212 | | 7815551212 |
| @room1.any.org | | @room6.any.org |
| 8885551212 | 8885551212 | 8885551212 |
| @room5.any.org | @room5.any.org | @room5.any.org |

FIG. 4 shows the steps of a SUBSCRIBE message containing at least the fields and delimiters: 7815551212@room#{1-4}. Time 1 401 shows the state of the data stored or accessible to the SPS when a subscribe 405 message arrives at the SPS. An acknowledgement 407 may follow from SPS to a watcher or requesting entity. SPS may use the “room#[1-4]” as a tagging sensor criterion, i.e., the criterion is initially satisfied by a detection of a tag in rooms 1 through 4. SPS may use a second criterion a tag string or identifier: “7815551212” as a tag criterion. Thus, the combination of criteria may be satisfied when the tag, 7815551212, is coupled to tagging sensors that fall in the range of room1 through room4, which may be four tagging sensors. At time 1, the 7815551212 tag identifier is coupled to room1, so the combination of criteria is satisfied and a notify message 409 may be sent by SPS to watcher. The notify message may include a string that fills in any wild-cards, ranges, or other pattern matching string that is satisfied. In this case, the notify message 409 may send back “7815551212@room1”. The watcher may provide an acknowledgement 410.

At time 2 411, a change occurs which causes the coupling of 7815551212@room1 to be removed from a list of couplings accessible to SPS. The SPS, as it continues to have a subscription 7815551212@room#[1-4].any.org, reports the change to watcher. Such a change may be reported with a second NOTIFY message 413.

At time 3, a change occurs which causes the coupling of 7815551212@room6 to be added to a list of couplings. Although the tag 7815551212 satisfies a first criterion, room6 does not satisfy a second criterion, and so no action is taken in relation to the subscription by watcher relating to 7815551212.

Some possible formats for wild-cards and range specifications in the fields of tag or tagging sensor include:

‘*’ may be a wildcard for a single character;

‘#’ may be a wildcard for multiple characters;

any pairing of characters by a hyphen between brackets, e.g., [1-4], may be a range designation, which may be a criterion that is satisfied by a single instance of a character in a range bounded by the first character and the second character in parenthesis. An embodiment may use wildcards and other pattern matching characters that are a subset of characters permitted in a Session Initiation Protocol or other widely implemented protocol.

FIG. 5 shows an embodiment of the presence server 500. The presence server comprises at least a central processing unit 501 that may receive input and transmit output via a network interface card 503 for connection to a network 505, including for example a local area network, or the internet.

Particular implementations and embodiments of the invention have been described. Note that although the criterion for the tag identifier and the criterion for the tagging sensor are shown based on order in a string having a delimiter between fields, other methods of specifying criteria not based on order may be similarly applicable. It is clear to a person skilled in the art that the invention is not restricted to details of the embodiments presented above, but that it can be implemented in other embodiments using equivalent means without deviating from the characteristics of the invention. The scope of the invention is only restricted by the attached patent claims.

What is claimed is:

1. A method for communicating presence information to a subscriber comprising the steps of:
receiving a register message having a presence comprising at least one first portion and at least one second portion;
receiving a subscribe message having at least one criterion;
matching the at least one criterion to the presence; and
transmitting a notify message having the at least one first portion to the subscriber.

2. The method of claim 1 wherein the first portion comprises at least one tag portion.

3. The method of claim 2 wherein the at least one criterion comprises at least one tag criterion and at least one tagging sensor criterion.

4. The method of claim 3 wherein the step of receiving a register message comprises:
receiving the register message at a first domain, the register message originating from a second domain.

5. The method of claim 3 wherein the register message comprises at least one session initiation protocol field.

6. The method of claim 3 wherein the register message comprises a domain.

7. The method of claim 3 wherein the step of transmitting a notify message comprises transmitting a notify message having session initiation protocol fields.

8. The method of claim 7 wherein the tag criterion comprises at least one wildcard.

9. The method of claim 7 wherein the tagging sensor criterion comprises at least one character representing at least one non-wildcard character.

10. The method of claim 9 wherein the at least one wildcard comprises a range designation.

11. A presence server for communicating presence information to a subscriber comprising:
a means for receiving a register message having a presence comprising at least one first portion and at least one second portion;
a means for receiving a subscribe message having at least one criterion;
a means for matching the at least one criterion to the presence; and
a means for transmitting a notify message having the at least one first portion to the subscriber.

12. The presence server of claim 11 wherein the first portion comprises at least one tag portion.

13. The presence server of claim 12 wherein the at least one criterion comprises at least one tag criterion and at least one tagging sensor criterion.

14. The presence server of claim 13 wherein the means for receiving a register message comprises:
receiving the register message at a first domain, the register message originating from a second domain.

15. The presence server of claim 13 wherein the register message comprises at least one session initiation protocol field.

16. The presence server of claim 13 wherein the register message comprises a domain.

17. The presence server of claim 13 wherein the means for transmitting a notify message comprises a means for transmitting a notify message having session initiation protocol fields.

18. The presence server of claim 17 wherein the tag criterion comprises at least one wildcard.

19. The presence server of claim 17 wherein the tagging sensor criterion comprises at least one character representing at least one non-wildcard character.

20. The presence server of claim 19 wherein the at least one wildcard comprises a range designation.

21. A method for reporting location of a tag having a tag identifier near a sensor having a unique identifier among sensors in a first domain comprising:
receiving the tag identifier;
transmitting the tag identifier and the unique identifier to a network node.

22. The method for reporting location of claim 21 wherein the step of transmitting the tag identifier comprises:
transmitting the tag identifier, and the unique identifier to a network node in a second domain.

23. The method for reporting location of claim 22 wherein the step of transmitting the tag identifier further comprises:
transmitting a packet having at least one session initiation protocol field.

24. The method of claim 23 further comprising concatenating the tag identifier with the unique identifier.

25. The method of claim 23 where the step of transmitting the tag further comprises addressing the packet to the subscription network center.

26. The method of claim 23 wherein the message comprises a status.

27. The method of claim 26 wherein the status comprises moving.

28. The method of claim 21 wherein the step of receiving the tag identifier further comprises wirelessly reading the tag.
